(19) United States
(12) Patent Application Publication
(10) Pub. No.: US 2018/0179899 A1
(43) Pub. Date: Jun. 28, 2018

(54) METHOD AND APPARATUS FOR BRAZED ENGINE COMPONENTS

(71) Applicant: General Electric Company, Schenectady, NY (US)

(72) Inventors: Gregory Terrence Garay, West Chester, OH (US); Weston Nolan Dooley, West Chester, OH (US)

(21) Appl. No.: 15/387,808

(22) Filed: Dec. 22, 2016

(51) Int. Cl. F01D 5/18

(52) U.S. Cl. CPC F01D 5/187; F05D 2220/30; F05D 2230/30; F05D 2260/202; F05D 2230/237; F05D 2240/307; F05D 2230/10

(57) ABSTRACT

A method and apparatus for brazed engine components include machining an engine component, such as using a casting process, to form an aperture in the component. A brazing material is provided in the aperture to close the aperture and seal an interior of the engine component. A shaped cooling hole is machined in the brazing material to cool the brazing material during engine operation.

### BACKGROUND OF THE INVENTION

Turbine engines, and particularly gas or combustion turbine engines, are rotary engines that extract energy from a flow of combusted gases passing through the engine onto a multitude of rotating turbine blades.

Gas turbine engines for aircraft are designed to operate at high temperatures to maximize engine efficiency, so cooling of certain engine components, such as the high pressure turbine and the low pressure turbine, can be beneficial. Typically, cooling is accomplished by ducting cooler air from the high and/or low pressure compressors to the engine components that require cooling. Temperatures in the high pressure turbine are around 1000° C. to 2000° C. and the cooling air from the compressor is around 500° C. to 700° C. While the compressor air is a high temperature, it is cooler relative to the turbine air, and can be used to cool the turbine.

Contemporary turbine blades generally include one or more interior cooling circuits for routing the cooling air through the blade to cool different portions of the blade, and can include dedicated cooling circuits for cooling different portions of the blade, such as the leading edge, trailing edge and tip of the blade.

### BRIEF DESCRIPTION OF THE INVENTION

In one aspect, aspects of the disclosure relate to a method of brazing engine components for a turbine engine including (1) filling an aperture in the engine component with a filling material and (2) forming a shaped cooling passage in the filling material, wherein the shaped cooling passage is smaller in cross-section than the hole.

In another aspect, aspects of the disclosure relate to a method of brazing an airfoil cast core including a casting hole remnant of a casting process including (1) filling the casting hole with a brazing material having a lower melting point than the cast core and (2) forming a shaped cooling passage into the brazing material. The shaped cooling passage includes an inlet and an outlet with variable cross-sectional area along at least a portion of the shaped cooling passage in a flow direction through the shaped cooling passage.

In yet another aspect, aspects of the disclosure relate to a cast component for a turbine engine including a wall separating an interior from an exterior. A cooling circuit is located within the cast component and includes a cooling passage extending at least partially through the interior. A casting hole is formed in the wall remnant of a casting process forming the cast component. A volume of filling material is provided in the casting hole having a melting point lower than that of the wall. A shaped cooling passage is formed in the filling material having a variable cross-sectional area along at least a portion of the shaped cooling passage.

### BRIEF DESCRIPTION OF THE DRAWINGS

In the drawings:

FIG. 1 is a schematic cross-sectional diagram of a gas turbine engine for an aircraft.

FIG. 2 is a perspective view of an airfoil of the engine of FIG. 1 in the form of a blade.

FIG. 3 is a cross-sectional view of the airfoil of FIG. 2 taken across section 3-3 illustrating interior cooling passages.

FIG. 4 is a sectional view of the airfoil of FIG. 2 taken across section 4-4 illustrating a casting hole formed in a wall of the airfoil.

FIG. 5 is a sectional view of FIG. 4 illustrating a volume of brazing material provided in the casting hole.

FIG. 6 is a sectional view of FIG. 5 illustrating a shaped cooling passage formed in the brazing material.

FIG. 7 is a sectional view similar to FIG. 6 illustrating an alternate orientation for the shaped cooling passage formed in the brazing material.

FIG. 8 is a sectional view similar to FIG. 6 illustrating an alternate conic shaped cooling passage.

FIG. 9 is a sectional view similar to FIG. 6 illustrating an alternate shaped cooling passage with non-linear walls.

FIG. 10 is a flow chart illustrating a method of brazing an engine component according to aspects as described herein.

### DESCRIPTION OF EMBODIMENTS OF THE INVENTION

The described aspects are directed to a shaped cooling passage in a braze for an engine component and method of brazing and forming the shaped passage hole. For purposes of illustration, the present invention will be described with respect to an airfoil of a turbine for an aircraft gas turbine engine. It will be understood, however, that the invention is not so limited and can have general applicability within an engine, to multiple engine components requiring brazing. The applications can also have applicability in non-aircraft applications, such as other mobile applications and non-mobile industrial, commercial, and residential applications.

Furthermore, the present invention will be described with respect to a cast hole in an engine component filled by a brazing material to form a braze. It will be understood, however, that the invention is not so limited and can have general applicability with any hole in an engine component requiring filling. It will be further understood that the invention is not limited to a brazing material for filling the hole of the engine component, and can include any material sufficient to the system, such as soldering or epoxying, for example. Such a material can include a material having a lower melting point than the engine component, while having a higher melting point than engine operational temperatures. Further still, the material can be a hardening material, which is capable of withstanding shaping operations to form the shaped cooling passage as described herein as well as heightened engine operating temperatures.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

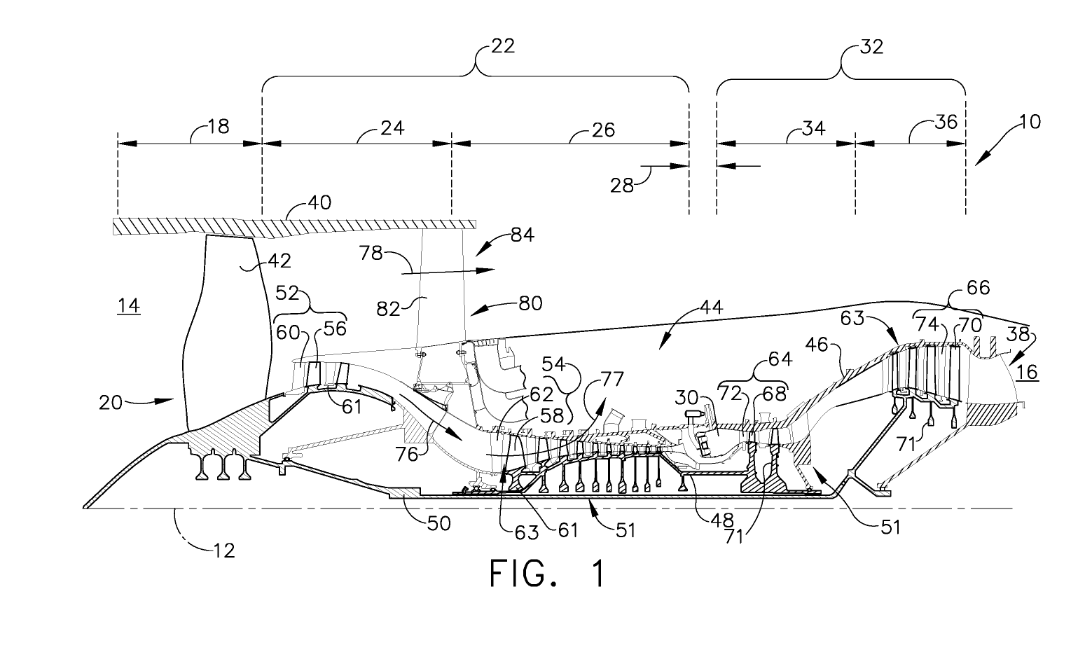

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized airflow 76 to the HP compressor 26, which further pressurizes the air. The pressurized airflow 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

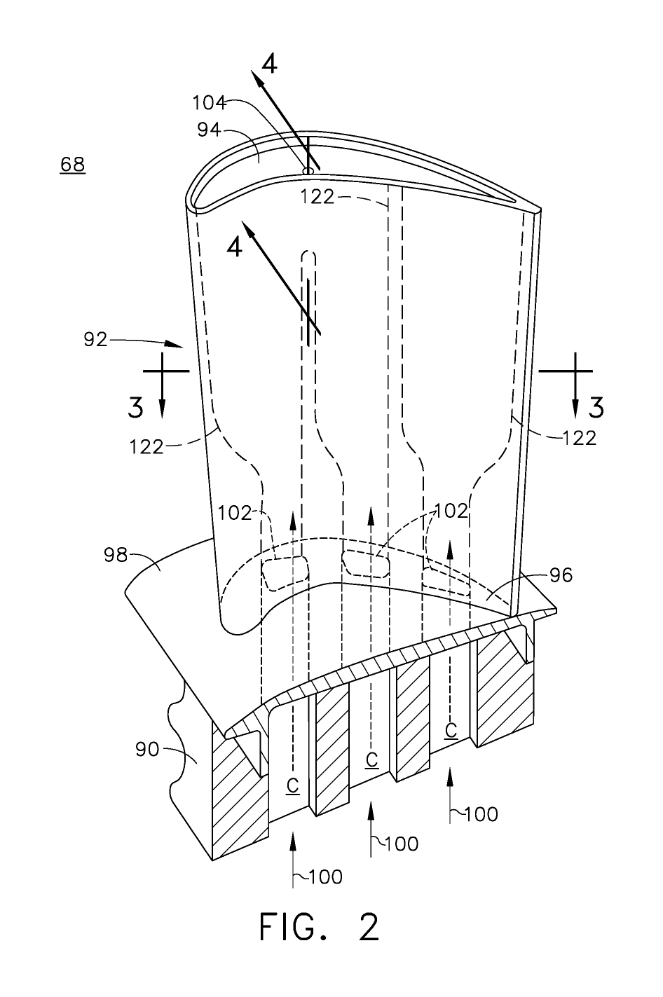

FIG. 2 is a perspective view of an engine component in the form of one of the turbine blades 68 of the engine 10 from FIG. 1. The turbine blade 68 includes a dovetail 90 and an airfoil 92. The airfoil 92 includes a tip 94 and a root 96 defining a span-wise direction therebetween. The airfoil 92 mounts to the dovetail 90 at a platform 98 at the root 96. The platform 98 helps to radially contain the turbine engine mainstream air flow. The dovetail 90 can be configured to mount to a turbine rotor disk 71 on the engine 10. The dovetail 90 further includes at least one inlet passage 100, exemplarily shown as a three inlet passages 100, each extending through the dovetail 90 to provide internal fluid communication with the airfoil 92 at a passage outlet 102. It should be appreciated that the dovetail 90 is shown in cross-section, such that the inlet passages 100 are housed within the body of the dovetail 90.

The airfoil 92 can include one or more interior cooling passages 122 extending in the span-wise direction from the root 96 to the tip 94. The cooling passages 122 can extend partially or fully through the airfoil 92, and can interconnect with one another.

An aperture 104 is formed in the tip 94. The aperture 104 can be remnant of the casting process used to form the airfoil 92. The aperture 104 can be a casting hole, in one example. In additional examples, the aperture 104 can be any relevant hole, such as a oxidized aperture or area of an engine component requiring repair via a braze process, in one additional non-limiting example. Such a casting process can be ceramic core casting, in one non-limiting example. While shown as a single aperture 104, it should be understood that the airfoil 92 can include multiple apertures 104, as determined by the particular casting process. Furthermore, the aperture 104 is not limited to at the tip 94 of the airfoil 92. The location of the aperture 104 can also be dictated by the particular casting process, for example, or the particular engine component being cast. In such an engine component other than the airfoil 92, the aperture 104 can be formed at any position necessary in casting the component. Further still, the aperture 104 can be purposely located during the casting process. Such location can include positioning the aperture 104 for directing a flow of cooling flow, providing a cooling film to a particular location, or for controlling a flow at the tip or throughout the airfoil in non-limiting examples.

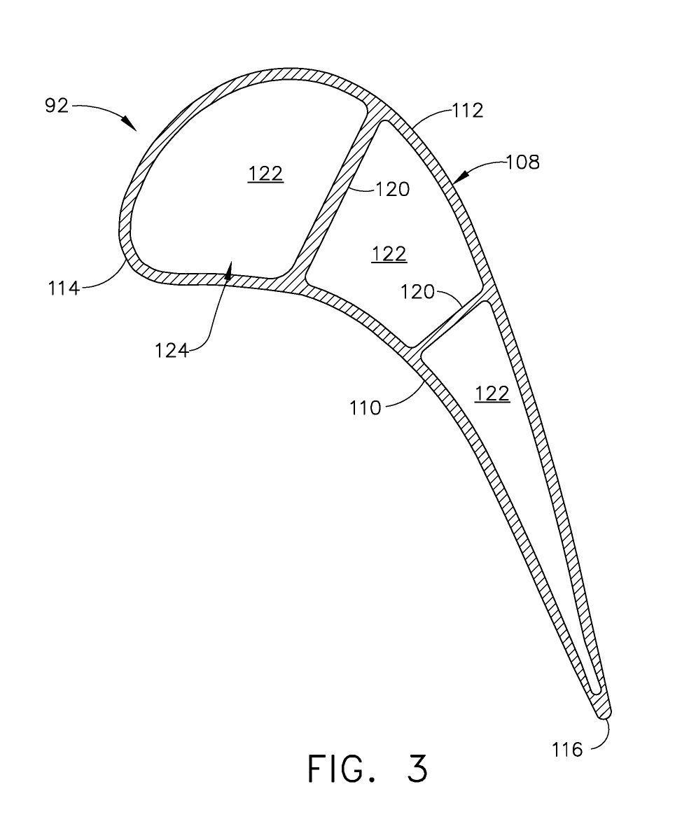

Referring to FIG. 3, the airfoil 92, shown in cross-section along section 3-3 of FIG. 2, includes an outer wall 108 including a concave-shaped pressure sidewall 110 and a convex-shaped suction sidewall 112 which are joined together to define the shape of the airfoil 92. The airfoil 92 includes a leading edge 114 and a trailing edge 116, defining a chord-wise direction. The airfoil 92 has an interior 118 defined by the outer wall 108. The blade 68 rotates in a direction such that the pressure sidewall 110 follows the suction sidewall 112. Thus, as shown in FIG. 3, the airfoil 92 would rotate upward toward the top of the page. In the case of a stationary vane as the engine component, the airfoil would not rotate.

One or more ribs 120 can divide the interior 118 into multiple cooling passages 122 extending in the substantially span-wise direction. The cooling passages 122 can extends partially or fully from the root 96 to the tip 94 (FIG. 2). Additionally, one or more cooling passages 122 can fluidly couple to one another to form a cooling circuit 124.

It should be appreciated that the ribs 120, passages 122, and cooling circuit 124 as shown are exemplary, and can be single channels extending in the span-wise direction, or can be complex cooling circuits, having multiple features such as passages, channels, inlets, pin banks, circuits, sub-circuits, film holes, plenums, mesh, turbulators, or otherwise and such details are not germane to the invention.

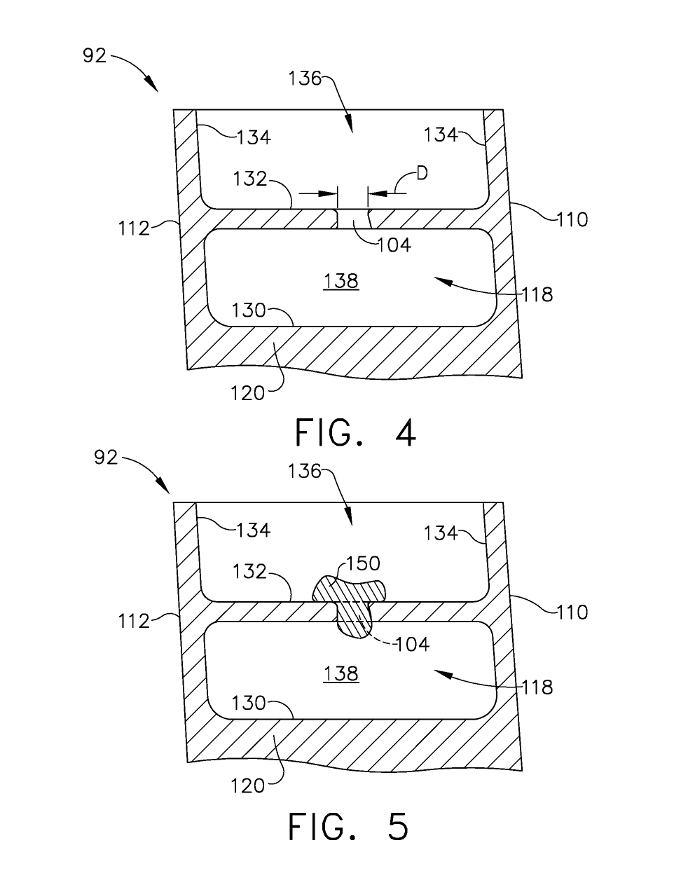

FIG. 4 illustrates a partial cross section of the airfoil 92 of FIG. 2, taken along section 4-4. The rib 120 spans the pressure sidewall 110 and the suction sidewall 112, and extends partially in the span-wise direction, terminating at a rib end 130 spaced from the tip 94. A tip cap 132 encloses the interior 118 at the tip 94. A tip turn 138 is defined between the rib end 130 and the tip cap 132. The tip turn 138 can couple cooling passages 122 (FIG. 3) to form the cooling circuit 124. Tip walls 134 surround the tip 94, extending above the tip cap 132 from the pressure sidewall 110 and the suction sidewall 112 to define a tip passage 136.

The aperture 104 is formed in the tip cap 132. The aperture 104 has a diameter D. The diameter D can be too wide for the particular location of the airfoil as compared to what is desirable, and can permit an undesired volume of cooling fluid to exhaust from the interior 118. The diameter D can be between 0.015 and 0.075 inches, and can be 0.050 inches, in non-limiting examples.

In order to enclose the aperture 104 to prevent excessive loss of cooling fluid, a volume of filling material, described herein as a brazing material 150 is provided into the aperture 104 to seal the interior 118. Referring to FIG. 5, the brazing material 150 fills the aperture 104. The brazing material 150 is a material having a lower melting point than that of the airfoil 92 or engine component. Examples of brazing materials include those described in U.S. Pat. No. 5,666,643 or U.S. Pat. No. 6,530,971, both of which are included herein by reference. The lower melting point of the braze alloy prevents melting of the airfoil 92 during high temperature application of the melted brazing material 150 to the aperture 104. It should be appreciated that while described in relation to a brazing material 150, the filling material can be any sufficient material to fill the hole 104, withstand formation of a shaped cooling hole in the filling material, as well as engine operational temperatures. Such materials, in non-limiting examples, can include non-braze metals or epoxies, and include processes such as welding or soldering. As such, any description related to a braze material, brazing material, a braze, or brazing operations can include any sufficient material and method of utilizing such a material to fill the hole 104.

The lower melting point of the brazing material 150 reduces the maximum operating temperature of the airfoil 92, as the brazing material 150 will melt before reaching maximum operating temperatures for the airfoil 92. As such, the maximum operating temperature of the engine is reduced, limiting engine efficiency. In order to operate under the heightened temperatures without negatively affecting the engine efficiency, a cooling passage can be formed in the brazing material 150. As such, simple, non-shaped linear holes are drilled into the brazing material 150 to help keep the brazing material 150 cool during engine operation. Such simple, non-shaped, linear holes can lead to inefficiencies of the cooling fluid passing through the airfoil 92, as well as blockages formed from particulate matter passing through the airfoil 92.

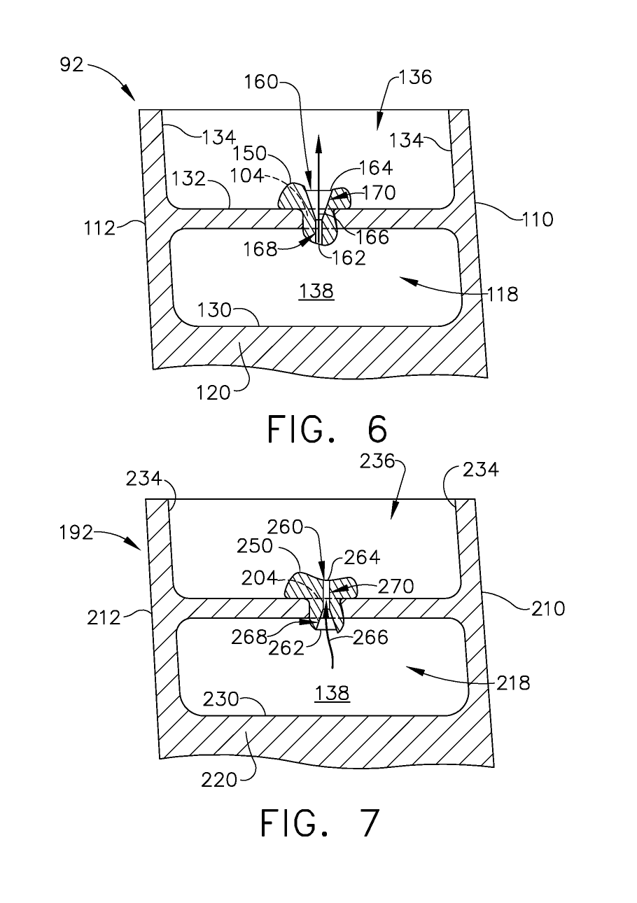

Referring to FIG. 6, a shaped cooling passage 160 is provided in the brazing material 150. The shaped cooling hole passage includes an inlet 162 and an outlet 164. The outlet 164 can be flat, and can be parallel to the tip cap 132. An airflow path 166 defining an airflow direction extends between the inlet 162 and the outlet 164, defining a flow direction from the inlet 162 to the outlet 164. A shaped cooling passage 160 is a cooling passage having a variable cross-sectional area along at least a portion of the cooling passage 160 between the inlet 162 and the outlet 164 or having a non-linear centerline defined through the length of the passage 160, while a non-shaped cooling passage has a constant cross-sectional area along the entirety of the passage with a single-line, linear centerline defined through the passage.

The shaped cooling passage 160 includes a variable cross-sectional area along at least a portion of the airflow path 166 and is separated into a first portion 168 and a second portion 170. The first portion 168 is linear, including a cylindrical profile. The cylindrical first portion 168 can meter the flow of cooling fluid entering the shaped cooling passage 160. The second portion 170 can be a conical, having a variable cross-section defining a diverging profile extending from the first portion 168. The diverging profile of the second portion 170 can slow and disperse a flow of cooling fluid exhausting from the shaped cooling passage 160 to provide a cooling film over the tip cap 132. The dispersed flow of cooling fluid can cover a wider area of the tip cap 132 as opposed to a typical non-shaped cooling passage or film hole, improving film cooling along the tip 94 as well as cooling efficiency. Additionally, the conical second portion 170 reduces the amount of braze material in the aperture 104 and therefore reduces the occurrence of low-melting-point braze material liberating from the aperture 104 during high temperature engine operation.

FIG. 7 shows an airfoil 192 having an alternative shaped cooling passage 260. FIG. 7 can be substantially similar to FIG. 6. As such, similar numerals will be used to describe similar elements increased by a value of one hundred, and the discussion will be limited to distinctions from FIG. 6.

The shape cooling passage 260 includes a variable cross-sectional area along at least a portion of an airflow path 266 defining an airflow direction. A first portion 268 of the shaped cooling passage 260 has a conical shape, with a converging profile extending toward a second portion 270. The second portion 270 is linear, having a cylindrical profile. The converging profile of the first portion 268 can accelerate the flow of cooling fluid passing through the shaped cooling passage 260 and the second portion 270 can meter the flow of cooling fluid exhausted from the shaped cooling passage 260.

The accelerated flow through the first and second portion 268, 270 can increase convective cooling along the shaped cooling passage 260, increasing the maximum operating temperature of the brazing material 250 and, thus, the airfoil 192 or component. Additionally, the accelerated flow of cooling fluid exhausting from the shaped cooling passage 260 can improve film cooling along the tip cap 132 (FIG. 4).

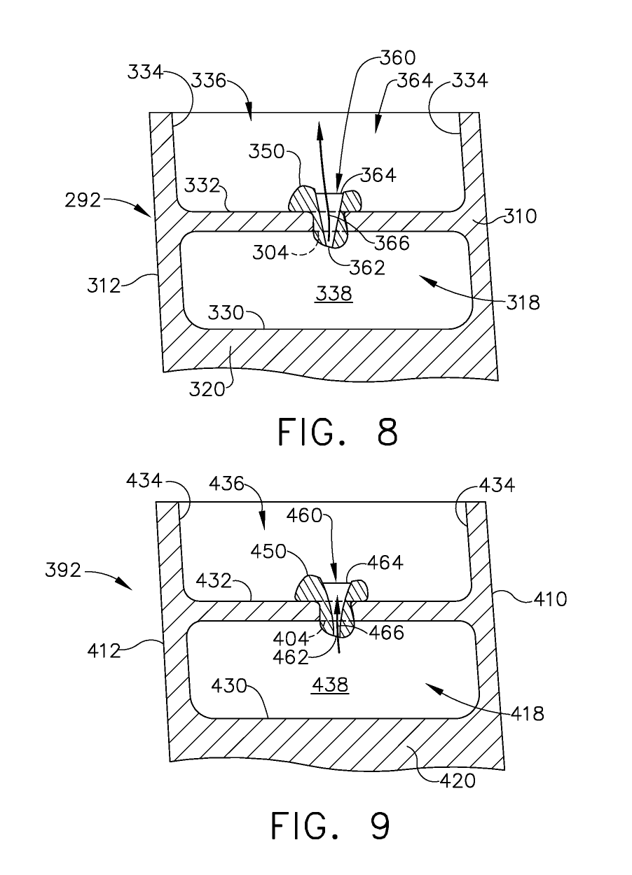

FIG. 8 illustrates another alternative shaped cooling passage 360 for an airfoil 292. FIG. 8 can be substantially similar FIG. 6. As such, similar numerals will be used to describe similar elements increased by a value of two hundred, and the discussion will be limited to distinctions from FIG. 6.

The shaped cooling passage 360 includes a variable cross-sectional area along an airflow path 366 defining an airflow direction extending between an inlet 362 and an outlet 364 having a conical shape, with a diverging profile having linear sidewalls. The diverging profile can meter a flow of cooling fluid passing through the airflow path 366 of the shaped cooling passage 360, and provide the cooling fluid as a cooling film over a greater area of the tip cap 332 as opposed to a typical film hole or cooling passage.

It should be appreciated that the shaped cooling passage 360 is not limited as shown, and can include a converging profile, or a combination of converging and diverging. The degree at which the shaped cooling passage 360 diverges is not limited as shown, and can vary among particular airfoils 292 or components.

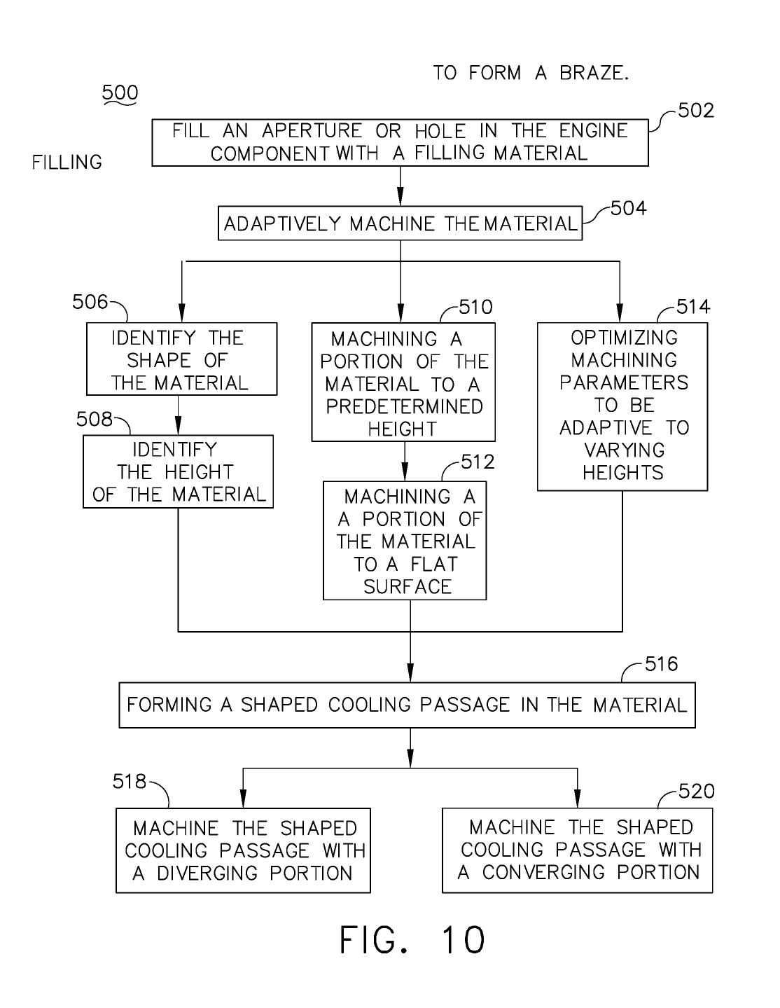

FIG. 9 illustrates yet another alternative shaped cooling passage 460 for an airfoil 392. FIG. 9 can be substantially similar to FIG. 9. As such, similar numerals will be used to describe similar elements increased by a value of three hundred, and the discussion will be limited to distinctions from FIG. 6.

The shaped cooling passage 460 having a variable cross-sectional area along an airflow path 466 defining an airflow direction extending between an inlet 462 and an outlet 464 having a conical shape, defining a diverging profile having non-linear sidewalls. The non-linear sidewalls can be used to affect the flow of fluid passing through the airflow path 466, such as by increasing or decreasing the rate of convergence or divergence of the airflow path 466. In an alternative example, the variable cross-sectional area of the shaped cooling passage 460 can include both converging and diverging portions.

It should be appreciated that the shaped cooling passages as shown in FIGS. 6-9 are by way of example only. The shaped cooling holes as described herein can include a passage having one or more portions. The shaped cooling passages include a variable cross-sectional area, which can include linear or non-linear sidewalls. The variable cross-sectional area, and portions thereof, can include increasing cross-sectional areas, decreasing cross-sectional areas, or a constant cross-sectional area in combinations with a variable cross-sectional area along a portion of the shaped cooling passage. Any combination of cross-sectional areas including increasing, decreasing, linear, non-linear, diverging, converging, unique, or constant in combination with the aforementioned is contemplated, and any combination thereof such that a variable cross-sectional area is defined along at least a portion of the shaped cooling passage. Additionally, it should be appreciated that the axis of the hole can be angled or curved with respect to the radial direction while including the aforementioned variations on cross-sectional areas.

Referring to FIG. 10, a method 500 of converting a hole in engine components, such as the airfoil as described herein, to a cooling passage can include (1) filling an aperture or hole in the engine component with a filling material, at 502, and (2) forming a shaped cooling passage in the filling material, at 516. The method can further include adaptively machining the filling material at 504. Adaptively machining the filling material can include identifying or shaping the filling material and forming the shaping cooling passage in the filling material based upon such identification or shaping. The filling material is amorphous after filling the aperture or hole, which poses challenges for machining the shaped cooling passage into the filling material.

The engine component can be any engine component requiring filling, such as a braze, to fill an oversized aperture or hole such as a casting hole. Such engine components can include an airfoil, combustor liner, blade, vane, or shroud in non-limiting examples, and can include any component with a hole remnant of casting of the engine component or requiring filling. Additionally, the component can be from original manufacture or from a repair operation, such as filling a hole formed from oxidization of an engine component. At 502, the method can include filling an aperture in the engine component with a filling material, such as that of FIG. 5, with the filling material 150 filling the aperture 104. The filling material 150 is any suitable material, such as a brazing material, having a melting point lower than that of the engine component and a melting point high enough to withstand engine operational temperatures.

Adaptively machining the filling material can include identifying the shape of or shaping the filling material prior to forming the shaped cooling passage. Adaptively machining the filling material can include one or more of (1) identifying the three-dimensional shape of the filling material, at 506, (2) machining a portion of the filling material to a predetermined height, at 510, or (3) optimizing the machining parameters to be adaptive and robust to varying material heights, at 514.

Identifying the three-dimensional shape of the filling material, at 506, can further include identifying the height of the material, at 508, which can be the height of the material extending from the hole. Identifying the three-dimensional shape of the material, at 506, or the height of the material, at 508, can include, for example, a vision system such as a laser based vision system. Such a vision system can provide information representative of the shape and height of the material, such as a three-dimensional geometrical representation of the particular material. With such information, the filling material can be adaptively machined based upon the maximum height in order to uniformly machine the material to form the particular shaped cooling passage, as well as the inlet, outlet, and passage thereof.

Machining a portion of the filling material to a predetermined height, at 510, can provide a uniform surface relative to the hole, providing for consistent forming of the shaped cooling passage. Machining a portion of the filling material to a predetermined height can further include machining a portion of the filling material to a flat surface, at 512. For example, as shown in FIGS. 6-9, the inlets 162, 262, 362, 462 and outlets 164, 264, 364, 464 of the shaped cooling passages 160, 260, 360, 460 can be flat. A flat inlet or outlet can be perpendicular to a radial axis based upon the engine centerline 12 (FIG. 1), for example, or can be perpendicular to a longitudinal axis extending through the shaped cooling passage. A flat inlet or outlet can provide for uniform provision of a flow of cooling fluid to the shaped cooling passage, or uniform exhaustion of the cooling fluid to form a cooling film along the exterior of the engine component.

Optimizing machining parameters to be adaptive to varying material heights, at 514, for example, can include optimizing the power of the cutting tool such that height doesn't matter. In another example, laser focus for laser drilling can be tailored to accommodate excess filling material and is benign for component with less than nominal filling material.

After adaptively machining the filling material, at 504, which can include one or more of steps 506, 508, 510, 512, 514, the method 500, at 516, can include forming a shaped cooling passage in the filling material. Such a shaped cooling passage can be formed by EDM, laser drilling, or by additive manufacturing methods, in non-limiting examples. The shaped cooling passages can be any passage as shown in FIGS. 5-9, or any passage having a variable cross-section extending in the span-wise direction along at least a portion of the shaped cooling passage, or in the direction of the flow path defined through the shaped cooling passage. For example, forming the shaped cooling passage, at 516, can further include forming a diverging portion, at 518, or a converging portion, at 520. A diverging portion includes an increasing cross-sectional area in the radially outward direction or the flow direction, such as that of FIG. 6, 8, or 9, while a converging portion includes a decreasing cross-sectional area in the radially outward direction or the flow direction, such as that of FIG. 7. It should be appreciated, however, that the shaped cooling passage can have any combination of converging, diverging, or otherwise variable portions, such that the cross-sectional area of the shaped cooling passage varies between the inlet and the outlet along the passage.

An alternative method can include a method of brazing an airfoil cast core including a casting hole remnant of a casting process can include: (1) filling the casting hole with a filling material having a lower melting point than the cast core and (2) machining a shaped cooling passage into the filling material with the shaped cooling passage having an inlet and an outlet, where the shaped cooling passage has a variable cross-sectional area along at least a portion of the passage between the inlet and the outlet.

Additionally, the method can include adaptively machining the braze, similar to step 504 of FIG. 10. Adaptively machining the brazing material, can be similar to steps 506, 508, 510, 512, 514 of method 500 of FIG. 10, such as identifying the shape of the braze and machining the braze to a predetermined height extending from the surface the casting hole is located in. Additionally, machining the shaped cooling passage into the brazing material with a variable cross-sectional area can include a converging portion or a diverging portion, in non-limiting examples.

The shaped cooling passage as provided in the brazing material, and as described herein, can provide for controlling and optimizing the film cooling provided through the shaped cooling passage. The shaped cooling passage can provide for metering the flow of cooling fluid through the shaped cooling passage, which can decrease the amount of cooling fluid passing through the airfoil or engine component, improving cooling efficiency within the airfoil or engine component. Additionally, the shaped cooling passage can provide for improved cooling film along the tip of the airfoil or along the exterior surface of the engine component, improving cooling film efficiency. Such an improvement can provide for higher engine operational temperatures, or reduced cooling fluid, improving engine efficiency.

Furthermore, adaptively machining the brazing material, as well as shaping the cooling passages reduces the amount of brazing material used and remaining at the casting hole. The reduced amount of brazing material reduces engine weight, particularly among multiple engine components, such as a plurality of airfoils on a disk. Additionally, the reduced amount of brazing material reduces the occurrence of low-melting-point braze material liberating from the aperture during high temperature engine operation.

Further still, the adaptive machining of the brazing material can be applied retroactively to existing brazes. For example, a typical cooling passage through a braze is a thin linear, cylindrical hole. Adaptive machining can be retroactively applied to existing brazes to shape the existing cooling passages. Such adaptive machining can be applied to existing engine components during regular maintenance or repair. Ideal candidates would include similar brazing material, with a desired shaped portion of the shaped cooling passage accessible from the exterior of the airfoil or engine component.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of converting a hole to a cooling passage in component of a turbine engine, the method comprising:
filling the hole with a filling material; and
forming a shaped cooling passage in the filling material, wherein the shaped cooling passage is smaller in cross-section than the hole.

2. The method of claim 1 further comprising adaptively machining the filling material wherein adaptively machining the filling material includes identifying or shaping the filling material and forming the shaped cooling passage in the filling material based upon such identification or shaping.

3. The method of claim 2 wherein adaptively machining the filling material further includes identifying a three-dimensional shape of the filling material.

4. The method of claim 3 wherein identifying the shape of the filling material further comprises sensing a height of the filling material extending from the hole.

5. The method of claim 3 wherein identifying the shape of the filling material includes a vision system.

6. The method of claim 2 wherein adaptively machining the filing material further includes shaping a portion of the filling material to a predetermined height extending from a surface the hole is located in.

7. The method of claim 6 wherein machining the filling material to a predetermined height includes machining a flat surface on the filling material.

8. The method of claim 2 wherein adaptively machining the filling material further includes optimizing machining parameters to be adaptive to varying filling material heights by accommodating variable filling material heights against a nominal height of the filling material.

9. The method of claim 1 wherein forming a shaped cooling passage in the filling material further includes machining the shaped cooling passage to have a diverging portion relative to an airflow path through the shaped cooling passage.

10. The method of claim 1 wherein forming a shaped cooling passage in the filling material further includes machining the shaped cooling passage to have a converging portion relative to an airflow path through the shaped cooling passage.

11. The method of claim 1 wherein at least a portion of the shaped cooling passage has a variable cross-section relative to an airflow path through the shaped cooling passage.

12. The method of claim 1 wherein the hole is a casting hole.

13. The method of claim 1 wherein the filling material is a brazing material and forms a braze at the hole.

14. The method of claim 1 wherein the hole is an oxidized area of an engine component requiring filling.

15. A method of brazing an airfoil cast core including a casting hole, remnant of a casting process, the method comprising:
filling the casting hole with a brazing material having a lower melting point that the cast core; and
forming a shaped cooling passage into the brazing material, with the shaped cooling passage having an inlet and an outlet;
wherein the shaped cooling passage includes a variable cross-sectional area along at least a portion of the passage between the inlet and the outlet.

16. The method of claim 15 further comprising adaptively machining the braze wherein adaptively machining the braze further includes identifying a three-dimensional shape of the braze.

17. The method of claim 16 wherein adaptively machining the braze further includes machining a portion of the braze to a predetermined height extending from a surface the casting hole is located in.

18. The method of claim 5 wherein the variable cross-sectional area includes a diverging portion.

19. A component for a turbine engine comprising:
a wall separating an interior from an exterior;
a cooling circuit located within the component and having a cooling passage extending at least partially through the interior;
a hole formed in the wall;
a volume of filling material provided in the hole having a melting point lower than that of the wall; and
a shaped cooling passage formed in the filling material having a variable cross-sectional area along at least a portion of the shaped cooling passage.

20. The component of claim 19 wherein the variable cross-sectional area defines a converging portion relative to an airflow direction through the shaped cooling passage.

21. The component of claim 20 wherein the variable cross-sectional area defines a diverging portion relative to an airflow direction through the shaped cooling passage.

22. The component of claim 19 wherein the wall further includes a tip of an airfoil.

23. The component of claim 22 wherein the hole is a casting hole.

24. The component of claim 23 wherein the filling material is a brazing material.
